(19) United States
(12) Patent Application Publication
(10) Pub. No.: US 2006/0094402 A1
(43) Pub. Date: May 4, 2006

(54) Security monitoring method in bluetooth device

(75) Inventor: Sang-Don Kim, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/265,912

(22) Filed: Nov. 3, 2005

(30) Foreign Application Priority Data
Nov. 3, 2004 (KR) 89036/2004

(51) Int. Cl. H04M 1/66; H04M 1/68; H04M 3/16; H04B 7/00

(52) U.S. Cl. 455/411; 455/41.2

(57) ABSTRACT

Disclosed is a security monitoring method in a Bluetooth device, the method including detecting transmission or reception of a predetermined monitor-target message when a user device is in a connection-available or authentication-available scan mode enabling a user to recognize the occurrence of the monitor-target message; and recording log information about the monitor-target message. Therefore, a user equipment monitors authentication and connection requests by using the Bluetooth connection feature, so that the user can recognize a connection set up and release between devices by using log record although the connection set up and release is generated without user's knowledge. In addition, since the user equipment notifies the user of authentication and connection set up (e.g., by using a beep, a vibration or other alerting means), the user can influence the connection set up and release.

### PRIORITY

This application claims priority under 35 U.S.C. §119(a) to an application entitled “Security Monitoring Method In Bluetooth Device” filed in the Korean Intellectual Property Office on Nov. 3, 2004 and assigned Ser. No. 2004-89036, the entire contents of which are incorporated herein by reference.

### BACKGROUND OF THE INVENTION

1. Field of the Invention

The present invention relates to a Bluetooth device, and more particularly to a method for accomplishing security monitoring.

2. Description of the Related Art

Bluetooth is a standard that is designed to support wireless communication between mobile devices, such as portable personal computers (PCs) and portable telephones, at a low price within a short range. Bluetooth uses radio frequencies in the 2.45 GHz ISM (Industrial Scientific Medical) band which does not require a wireless license, thereby enabling various digital devices to easily exchange voice data and other data with each other wirelessly without requiring a physical connection. For instance, Bluetooth wireless technology can be employed in a portable telephone and a laptop computer so that they can communicate with each other even without a cable. Bluetooth systems include personal digital assistants (PDAs), desktop computers, faxes, keyboards and joysticks, cellular phones, mobile terminals, and other digital devices.

A diagram illustrating general communication schemes between Bluetooth devices is shown in FIG. 1. A user equipment (UE) 100 including a Bluetooth chip establishes a wireless connection with peripheral Bluetooth devices 110 to 150 and supports point-to-point and point-to-multipoint connections. When the user equipment 100 performs a detection of a Bluetooth device, information about the peripheral Bluetooth devices 110 to 150 is displayed on the user equipment 100. Then, the user equipment 100 starts a connection set-up procedure for connecting the user equipment 100 to a device desired to be connected from among the detected Bluetooth devices. In this case, the user equipment requesting a connection to another Bluetooth device is called a “master device”, and a counterpart Bluetooth device receiving the connection request is called a “slave device”. The master-slave relationship may change after the connection is set up.

In order to establish a wireless connection between two Bluetooth devices (devices) an authentication procedure called “pairing” between the devices must be performed. After the authentication procedure is successfully performed, no further authentication is necessary. That is, a first device, to allow a connection thereto, must be operating in a specific mode (i.e., an inquiry scan mode or a page scan mode). A second device, in order to attempt a connection to the first device, must send an inquiry through a user interface so as to find a counterpart device (located in proximity to the second device), and attempts a connection by selecting a counterpart device desired to be connected when the counterpart device is displayed on a display screen of the second device.

A flow diagram illustrating a general pairing procedure between Bluetooth devices is shown in FIG. 2 After an inquiry scan state is performed in step 205, to receive an inquiry message from other devices a master device 200 broadcasts an inquiry message to detect a slave device 290 desired to be connected, in step 210. In this case, the slave device 290 may be either a device desired to be connected by the master device 200 or a device not desired to be connected by the master device 200, and is in an inquiry scan state 205.

In step 215, the slave device 290 having received the inquiry message sends its Bluetooth device address (BD_ADDR) and clock information to respond to the master device 200, and then enters a page scan state 220 for a connection set up. Although it is not shown, the inquiry message is received in all peripheral devices which are in an inquiry scan state, besides the slave device 290, so as to cause the same procedure in all peripheral Bluetooth devices which receive the inquiry message.

In step 225, the master device 200 sends a page message for synchronization, which has been obtained with reference to the received BD_ADDR and clock information, to the slave device 290. In step 230, the slave device 290 transmits a page response message including an ID packet in response to the received page message. In step 231, when the slave device 290 is in a security mode (which will be described below), the slave device 290 transmits a PIN (Personal Identification Number) code request message for a link set up to the master device 200 in step 235. In step 240, the master device 200 transmits a PIN code to the slave device 290. When the PIN code transmitted from the master device 200 to the slave device 290 is correct, each of the master device 200 and the slave device 290 exchanges a link key using the BD_ADDR (message) and a random number (RAND) (message) to/from each other in steps 245 and 250. In step 255, an authentication and connection procedure is performed using the link key between the master device 200 and the slave device 290.

In contrast, in step 231, when the slave device 290 is not in the security mode, the procedure proceeds directly to steps 245 and 250 for exchanges a link key without proceeding to steps 235 and 240, and then proceeds to step 255 for performing an authentication and connection procedure.

Hereinafter, the authentication procedure will be described in detail.

A flowchart illustrating a general authentication procedure according to an authentication mode of a Bluetooth device is shown in FIG. 3 In step 300, a slave device receives a connection request message from a master device. In step 305, the slave device determines whether its authentication mode is set to security mode 2 or 3. As a result of step 305, when the authentication mode of the slave device is set to security mode 2 or 3, the slave device determines whether the master device requesting a connection is a device which has been previously authenticated, in step 310. As a result of step 310, when it is determined that the master device is a device which has not been previously authenticated (i.e., a device without prior authentication), the slave device transmits a PIN code request message to the master device requesting a connection in step 315 and proceeds to step 320.

In step 320, if it is determined that a PIN code transmitted from the master device in response to the PIN code request message is not identical to a PIN code of the slave device, the requested connection is canceled and the authentication procedure ends in step 325. Although it is not shown, the slave device may provide the master device an opportunity to re-input a PIN code a predetermined number of times. In contrast, when it is determined in step 320 that the transmitted PIN code is identical to that of the slave device, the slave device exchanges a link key to/from the master device in step 330. Thereafter, the slave device performs authentication and connection set up for/to the master device in step 335.

Meanwhile, as a result of step 310, if it is determined that the master device is a device having been previously authenticated, the slave device proceeds to step 330 of exchanging a link key without performing a PIN code request procedure. Thereafter, the slave device performs authentication and connection set up for/to the master device in step 335.

Meanwhile, as a result of step 305, when the slave device is set to a non-secure mode, the slave device proceeds to step 330 with a security mode released. In step 330, the slave device exchanges a link key to/from the master device. In step 335, the slave device performs authentication and connection set up for/to the master device.

As described above, when a user's Bluetooth device is set in security mode 2 or 3, the user's Bluetooth device recognizes an authentication request from a counterpart device, so that it (i.e., the user's Bluetooth device) does not pose a security problem. However, in this case, an authentication request may be received repeatedly from an undesired counterpart device (i.e., a device with which a communication connection is not desired). Also, although the user's Bluetooth device is in the security mode, a counterpart device may attempt and establish a connection to the user's Bluetooth device without the user's recognition after the two devices have been connected to each other by sharing authentication information through an authentication procedure. Meanwhile, when a user's Bluetooth device is in a non-secure mode, a counterpart device can be directly connected to the user's Bluetooth device without a PIN code inquiry procedure between the two devices and may pose a security risk.

In order to increase a device's security, the Bluetooth standard has established security modes which will be described below. In a security mode, a Bluetooth device receives a personal identification number code (PIN code) from its counterpart device, and sets up a connection when the received PIN code coincides with that of the Bluetooth device.

Bluetooth includes three modes of security which are known as Security mode 1, Security mode 2 and Security mode 3. Each Bluetooth device operates in only one security mode at a time, which can be set up by the user.

Security mode 1 is a non-secure mode, in which a Bluetooth device does not perform any security procedure. In Security mode 1, security services, such as authentication and encryption, are completely ignored. This mode is used when security is not required.

Security mode 2 is a service-level security mode, in which access control is performed to access a service and a device. Also, it is possible to define various security policies and reliability levels for applications having different security requirements and being simultaneously operated, thereby applying a security mode to some limited services.

Security mode 3 is a link-level security mode, in which authentication and encryption services are provided. These services are based on a link key shared between Bluetooth devices.

The conventional Bluetooth connection procedure as described in the above examples may pose a security risk to the user's device. For example, many device's are set to operate in Security mode 1 (i.e., their security mode is released). The users set their device to operate with the security mode released for the sake of convenience. For example, when the security mode of a device is released, the device can easily establish communication with all Bluetooth devices which are within a given distance of the user's device without the user's input.

However, considering current Bluetooth devices usually include supplementary functions added thereto, it is inconvenient for a devices' user to input a PIN code (which is required by certain security modes) for authentication each time a Bluetooth device attempts to establish a connection with the user's device (or visa versa).

Moreover, even when the user's device is set to Security mode 2 or mode 3, the user's device may still be exposed to a security threat. This is because after an authentication has been established in a previous communication between a user's device and another Bluetooth device, a current communication does not require re-authentication. Accordingly, a communication can be established between a user's device and another Bluetooth device, without the user's knowledge and information can be leaked from the user's device to the other Bluetooth device For example, when a dial-up networking connection has been previously established between a user's device (e.g., a UE) and another Bluetooth device (e.g., a PC), bonding information between the devices (i.e., an identical link key obtained through their authentication procedures to each other) can be used for a future (e.g., a current) connection. Because the current connection can be established without the user's knowledge, information stored in the UE may be leaked to the PC by another user.

In order to prevent such leakage, the user personally must delete the previous bonding information which includes the PC's registration information in a Bluetooth database of the UE. Unfortunately, when it is necessary to establish another connection between the UE and the PC in the future, a complex authentication procedure must be repeated. This defeats an essential purpose of Bluetooth, which is to enable simple and effortless connections between Bluetooth devices.

### SUMMARY OF THE INVENTION

Accordingly, the present invention has been made to solve the above-mentioned problems occurring in the prior art, and an object of the present invention is to provide a method for accomplishing security monitoring during authentication and connection between Bluetooth devices.

Another object of the present invention is to provide a method for monitoring an authentication and connection procedure between Bluetooth devices so as to assure security even when the Bluetooth devices are connected to each other without their users' recognition.

Still another object of the present invention is to provide a method which enables a user to recognize an authentication request to a user equipment in a connection-available state or an authentication-available state and a connection request from an already-authenticated device while saving history thereof, thereby leaving evidence before or after a hacking incident.

To accomplish these objects, in accordance with one aspect of the present invention, there is provided a security monitoring method in a Bluetooth device, the method including detecting transmission or reception of a predetermined monitor-target message when a user device is in a connection-available or authentication-available scan state, enabling a user to recognize occurrence of the monitor-target message, and recording log information about the monitor-target message.

### BRIEF DESCRIPTION OF THE DRAWINGS

The above and other objects, features and advantages of the present invention will be more apparent from the following detailed description when taken in conjunction with the accompanying drawings, in which:

FIG. 1 is a diagram illustrating a general communication scheme between Bluetooth devices;.

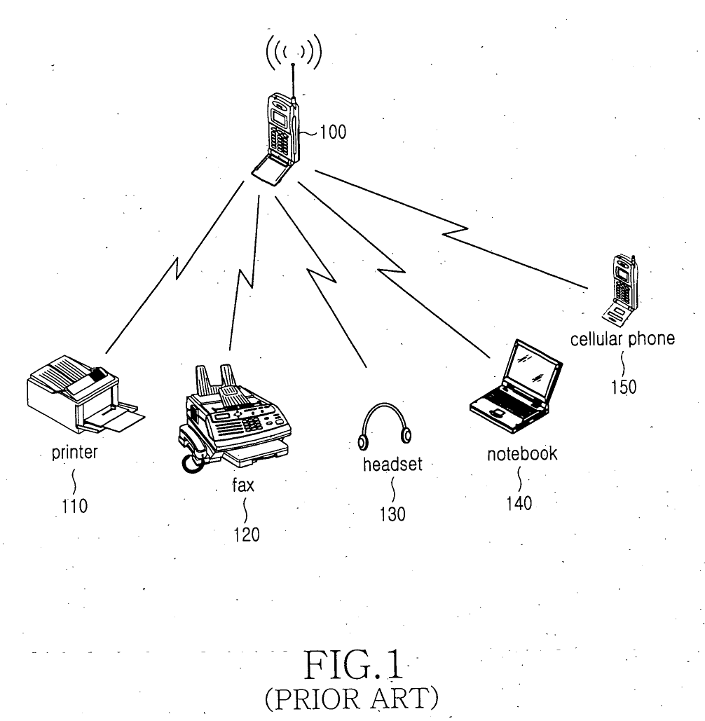

FIG. 2 is a flow diagram illustrating a general authentication procedure according to an authentication mode of a Bluetooth device;

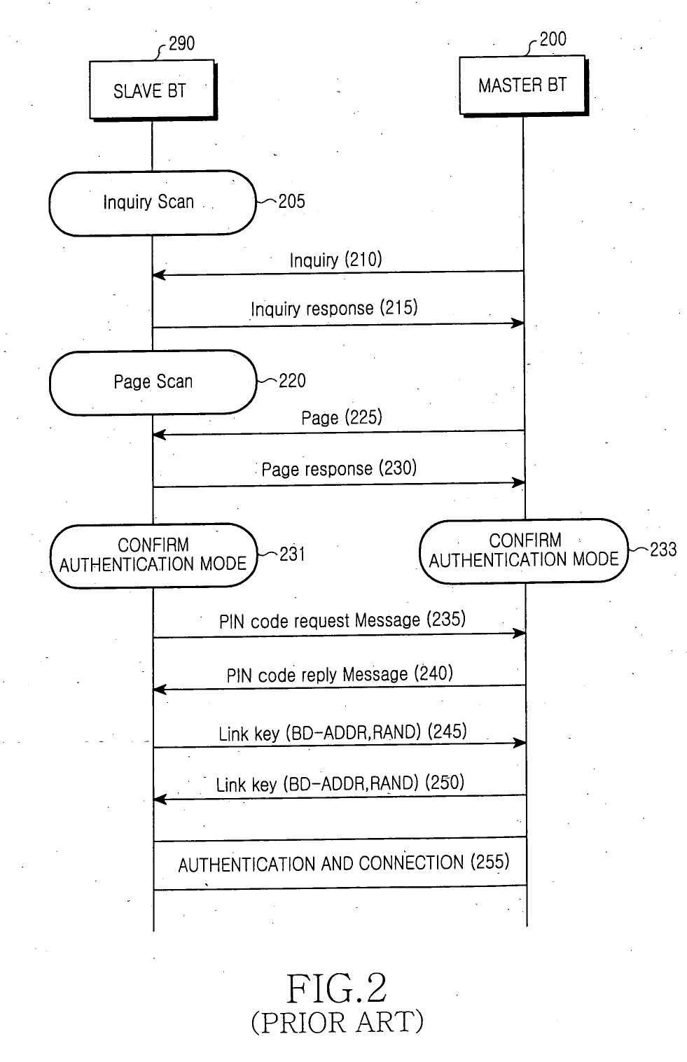

FIG. 3 is a flowchart illustrating a general paring procedure between Bluetooth devices;

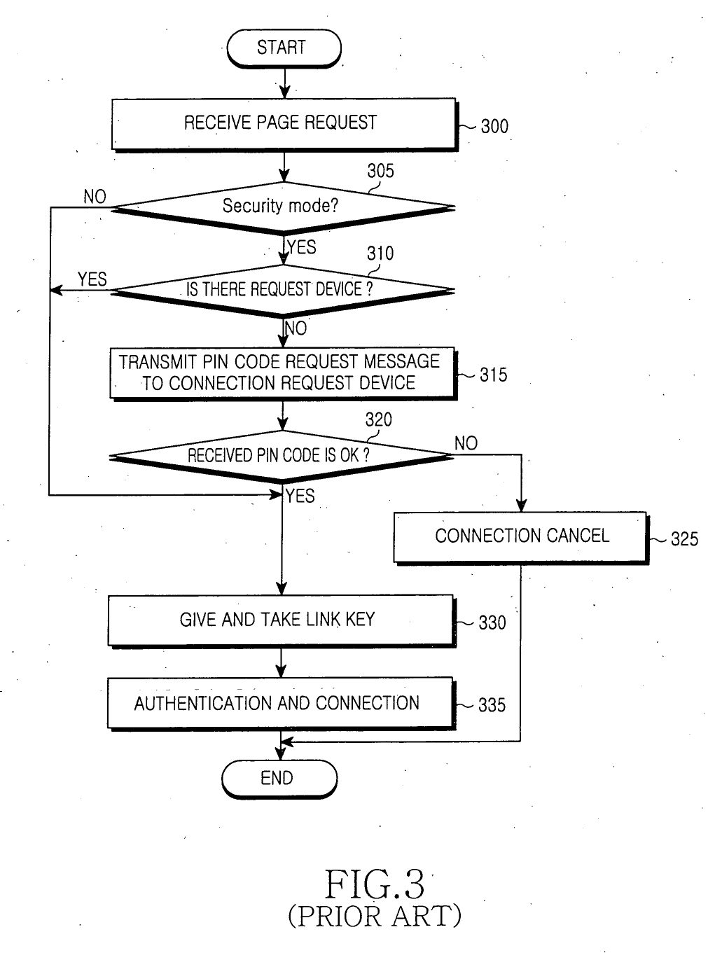

FIG. 4 is a flow diagram illustrating a security monitoring procedure of Bluetooth devices according to a preferred embodiment of the present invention; and

FIG. 5 is a flowchart illustrating a security monitoring procedure of a Bluetooth device according to a preferred embodiment of the present invention.

### DETAILED DESCRIPTION OF THE PREFERRED EMBODIMENT

Hereinafter, a preferred embodiment of the present invention will be described with reference to the accompanying drawings. In the following description of the present invention, a detailed description of known functions and configurations incorporated herein will be omitted when it may obscure the subject matter of the present invention. In addition, the terminology used in the description is defined in consideration of the function of corresponding components used in the present invention and may be varied according to a users', selection and/or to system or industry practices. Accordingly, the definition must be interpreted based on the overall content disclosed in the description.

In Bluetooth devices all operations between the devices are accomplished using a radio frequency (RF) connection. That is, when a slave device receives a command for authentication or connection from a master device, the slave device sends a request in response to the command, through which an authentication and connection procedure is performed between the two devices. Therefore, the slave device monitors each command transmitted from the master device. Also, the master device can monitor the request sent from the slave device.

As used herein, a procedure of monitoring command and request messages relating to security is known as “security monitoring”. Security monitoring is performed by an application, which displays information about a requested time, a requesting device, etc. for a connection between a master device and a slave device on a display window (so as to enable a user of a corresponding device to recognize the information), and logs and records the displayed information (so as to enable the user to confirm the information in the future).

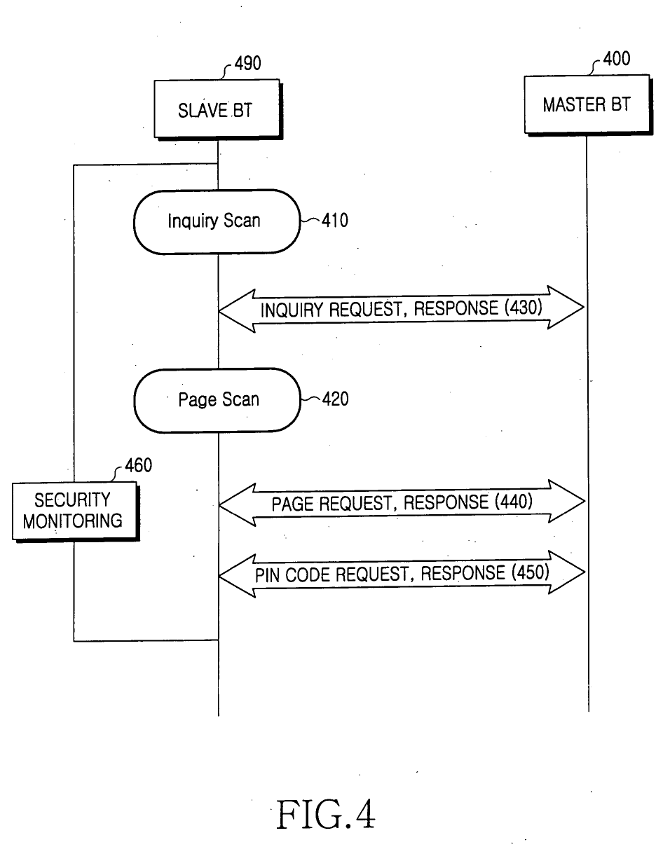

FIG. 4 is a diagram illustrating a security monitoring procedure between two Bluetooth devices according to a preferred embodiment of the present invention.

According to an embodiment of the present invention, there are three requests which are used for security monitoring with respect to a Bluetooth device. These three requests are known as an inquiry request and response (message) 430, a PIN code request and response (message) 450 and a paging request and response (message) 440, and will be described in more detail hereinbelow. A monitor-target message includes at least one of the inquiry request, the PIN code request and the paging request.

An inquiry request and response 430 which is received for detection in an inquiry scan state 410. When a user equipment 490 according to an embodiment of the present invention receives an inquiry request and response 430 to locate the user equipment 490 for authentication from a counterpart device 400 while the user equipment 490 is in the inquiry scan state 410 and a page scan state 420, the user equipment 490 notifies the user of the time the inquiry request and response 430 was received, and logs and records the time in a memory or in a storage device (both of which are not shown).

A PIN (Personal Identification Number) code request and response 450 for pairing is a numerical code which is used for security purposes, and which is input by the user or is (previously) stored in a Bluetooth device. The user equipment 490 monitors the PIN code request and response 450 transmitted for authentication from the counterpart device 400 to the user equipment 490 regardless of a set security mode.

A paging request and response 440 is received for connection in the page scan state 420. When the user equipment 490 receives a connection request from a registered counterpart device 400 having been previously authenticated, the user equipment 490 creates and stores log information (in a memory, storage device, etc. —not shown) which represents when the user equipment 490 receives the connection request from the counterpart device 400. In addition, the user equipment 490 notifies the user of the connection request by a beep, a vibration, a visual flash or through a display window which has been determined in advance in order to inform the user, so that it is possible to prevent the connection in advance (i.e., before the connection is authorized) without changing a Bluetooth connection-available set-up mode.

In addition to the information which is stored as result of the inquiry request and response 430, the PIN code request and response 450, and the paging request and response 440, a link key exchanging procedure, reception/transmission of data information after connection, connection release, etc. (all of which are not shown) may be stored in the same or in another log record, and may be reported to the user by a beep or through a display window.

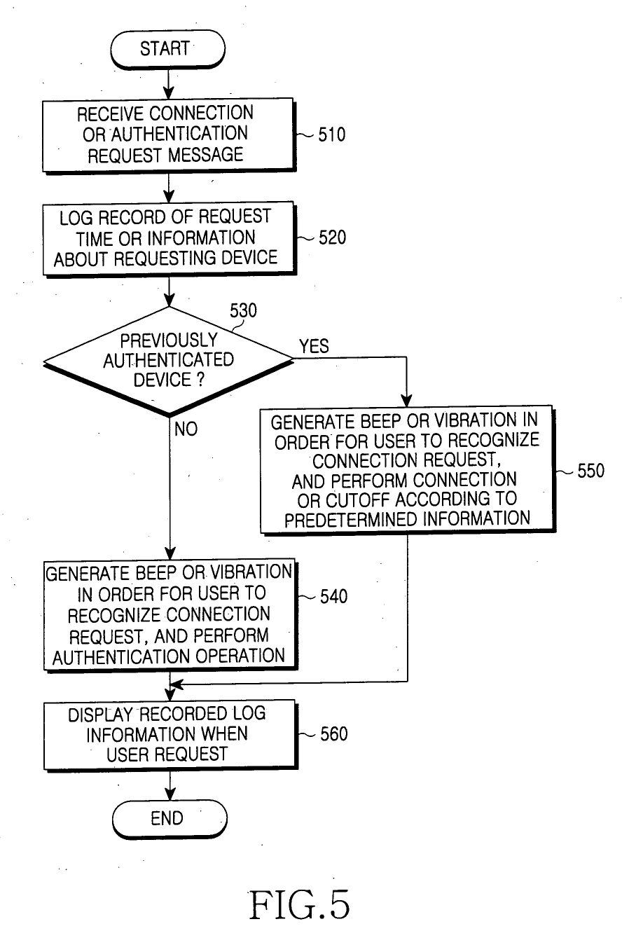

A flowchart illustrating a security monitoring procedure of a Bluetooth device according to a preferred embodiment of the present invention is shown in FIG. 5.

When a user equipment receives/transmits a monitor-target message (such as a connection request, an authentication request, etc.) from/to a counterpart Bluetooth device in step 510, the user equipment records the generation (reception or transmission) time of the monitor-target message and information about the counterpart Bluetooth device as log information in step 520. In step 530, the user equipment determines whether the counterpart Bluetooth device has been previously connected and authenticated. As a result of step 530, when it is determined that the counterpart Bluetooth device has been previously connected and authenticated, the user equipment proceeds to step 550. In step 550, the user equipment informs the user by generating a beep, a vibration or flashing a light (e.g., illuminating a light emitting diode (LED)) so that the user can recognize the generation of the monitor-target message. At the same time, according to information which was preset by the user, the user equipment either directly allows connection to the counterpart Bluetooth device or terminates a connection to the counterpart Bluetooth device although the user has no control. In contrast, as a result of step 530, when it is determined that the counterpart Bluetooth device is a device without a prior authentication for connection, the user equipments proceeds to step 540. In step 540, the user equipment generates a beep, a vibration, etc. to inform the user of the requested connection from the counterpart Bluetooth device or of a connection, and performs a procedure for authentication and connection set up. In this case, the user equipment may display a progress procedure for connection to the counterpart Bluetooth device on a display window. In step 560, when requested by the user, the user equipment outputs the recorded log information to the display window so that the user can confirm the generation time of the monitor-target message and/or information about the counterpart Bluetooth device.

According to the embodiments of the present invention, a user equipment monitors authentication and connection requests by using the Bluetooth connection feature, so that the user can recognize the occurrence of connection set up and release between devices by using a log record although the occurrence is generated without user's knowledge. Also, according to the embodiments of the present invention, the user equipment notifies the user of authentication and connection set up by a beep or vibration, so that the user can instantly recognize the connection between the user equipment and a counterpart Bluetooth device.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. A security monitoring method in a Bluetooth device, the method comprising of the steps of:
a) detecting a transmission or a reception of a predetermined monitor-target message when a user device is in one of a connection-available or an authentication-available scan mode;
b) enabling a user to recognize an occurrence of the monitor-target message; and
c) recording log information about the monitor-target message.

2. The method as claimed in claim 1, wherein the monitor-target message is an inquiry request message received for detection in an inquiry scan state and a page scan state.

3. The method as claimed in claim 1, wherein the monitor-target message is a paging request message received for connection in the page scan state.

4. The method as claimed in claim 1, wherein the monitor-target message is a PIN code request message received for authentication in the page scan state.

5. The method as claimed in claim 1, wherein, in step b), a user of the user device is notified of the occurrence of the monitor-target message using at least one of by an audible tone, a vibration and a visual display on a display window.

6. The method as claimed in claim 1, wherein the log information includes a time corresponding to the time of the detecting the transmission or the reception of the monitor-target message, information about a counterpart Bluetooth device, and a record of a progress procedure according to the monitor-target message.

7. The method as claimed in claim 1, wherein the monitor-target message includes an inquiry request and response message, a page request message, a paging response message, a PIN (Personal Identification Number) code request and response message, a link key exchange message, a reception and transmission of data information message, and a message relating to connection set up and release.

8. The method as claimed in claim 6, further comprising displaying on a display window a procedure for authentication of and connection with a counterpart device according to the monitor-target message.
